(19) United States
(12) Patent Application Publication
(10) Pub. No.: US 2026/0000078 A1
(43) Pub. Date: Jan. 1, 2026

(54) ANTI-MICROBIAL SYSTEM

(71) Applicant: The Procter & Gamble Company, Cincinnati, OH (US)

(72) Inventors: John August WOS, Mason, OH (US); Hilda Andamiche NAMANJA-MAGLIANO, Loveland, OH (US); José Carlos GARCIA-GARCIA, Cincinnati, OH (US); Howard David HUTTON, III, Oregonia, OH (US); Isoken Omosefe IGWEKALA-NWEKE, Springdale, OH (US); Amanda Brooke BRODBECK, Cincinnati, OH (US); Ryan Michael WEST, West Chester, OH (US); Dakota James BROCK, West Chester, OH (US); Victor Manuel ARREDONDO, Madeira, OH (US); Lijuan LI, Lebanon, OH (US); Sohini Sanjay BHATIA, Madeira, OH (US); Colleen Marie NEAL, Cincinnati, OH (US)

(21) Appl. No.: 19/062,618

(22) Filed: Feb. 25, 2025

Related U.S. Application Data
(60) Provisional application No. 63/557,812, filed on Feb. 26, 2024.
(60) Provisional application No. 63/558,670, filed on Feb. 28, 2024.
(60) Provisional application No. 63/712,718, filed on Oct. 28, 2024.
(60) Provisional application No. 63/719,856, filed on Nov. 13, 2024.

(51) Int. Cl. A01N 43/16; A01P 1/00

(52) U.S. Cl. CPC A01N 43/16; A01P 1/00

(57) ABSTRACT

An anti-microbial system and composition that includes a mixture of mono-rhamno-mono-lipids and di-rhamno-mono-lipids. The anti-microbial rhamnolipid mixture can provide environmentally-and user-friendly anti-microbial benefits to a variety of consumer goods. The rhamnolipid mixture can be prepared by hydrolyzing a conventional rhamno-di-lipid and, optionally, subjecting the resulting composition to a post-hydrolysis purification process.

### CROSS REFERENCE TO RELATED APPLICATIONS

This application claims the benefit, under 35 U.S.C. § 119(e), to U.S. Provisional Application Nos. 63/719,856 filed Nov. 13, 2024, 63/712718 filed Oct. 28, 2024, 63/558670 filed Feb. 28, 2024, and 63/557812, filed Feb. 26, 2024, the entire disclosure of which is fully incorporated by reference herein.

### FIELD

The present disclosure generally relates to an anti-microbial system comprising a rhamnolipid. More specifically, the present disclosure relates to an anti-microbial system comprising a mixture of rhamno-mono-lipids.

### BACKGROUND

Consumer goods such as personal care compositions (e.g., shampoos, conditioners, body washes and laundry detergents) typically contain an anti-microbial system comprising one or more anti-microbial agents (e.g., preservatives) to prevent product spoilage by microorganisms. The anti-microbial system can help keep the product stable throughout the life of the product including during shipping, handling, storage, and while the consumer is using the product. During use, the consumer can inadvertently introduce microorganisms as they open and close the product and these microorganisms can proliferate. Common anti-microbial agents used in personal care products and other consumer goods include isothiazolinones, parabens, benzyl alcohol, phenoxyethanol, and ethylenediaminetetraacetic acid (EDTA), and organics acids and their salts.

Anti-microbial systems are generally necessary for commercially available personal products, but some consumers prefer products that are considered more natural or sustainable and/or include fewer ingredients. Anti-microbial agents that are perceived as naturally derived or sustainably may not be suitable for use in some personal care compositions, and modifying the anti-microbial system of a product to reduce or eliminate certain anti-microbial agents can have a negative impact on microbiological safety requirements. Thus, there is a need for efficacious, naturally derived and sustainable preservatives.

Glycolipids are a diverse group of naturally occurring molecules made up of a sugar polar group and a lipid group. The two main commercial classes of glycolipids are rhamnolipids, which are produced via bacterial+fermentation, and sophorolipids, which are produced via yeast fermentation of mixed oil & sugar feed. Glycolipids are generally seen as environmentally friendly chemicals that enable green credentialling, and some glycolipids (e.g., rhamnolipids) are known to have anti-microbial activity. For example, U.S. Pat. No. 10,674,726 discloses a bactericidal composition comprising a rhamnolipid. However, the rhamnolipids described in U.S. Pat. No. 10,674,726 are all di-lipids, which not be suitable for use in certain compositions and/or may not provide a desired level of broad spectrum anti-microbial efficacy.

Accordingly, there is a need for an improved rhamnolipid anti-microbial composition.

### SUMMARY

Disclosed herein is an anti-microbial system, comprising a mono-rhamno, mono-lipid of structure I and di-rhamno, mono-lipid of structure II.

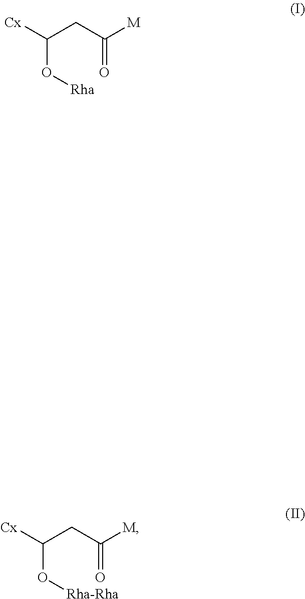

wherein Rha is rhamnose, Cx is a C4-C22 alkyl, aryl, heteroalkyl, heteroaryl, unsaturated alkenyl, or unsaturated heteroalkenyl, and M is a OH, alkyl, heteroalkyl, aryl, heteroaryl, hetero arylalkyl, arylalkyl, tauryl, O—X+, wherein X+ is a cation, or O—R1, wherein R1 is selected from an alkyl, branched alkyl, and cyclic alkyl, and stereoisomers thereof. Also disclosed herein is an anti-microbial composition comprising the foregoing anti-microbial system, a carrier and optional additional ingredients.

### BRIEF DESCRIPTION OF THE FIGURES

FIG. 1 shows exemplary rhamnolipid structures.

FIG. 2 shows an exemplary route for synthesizing rhamno-mono-lipids.

### DETAILED DESCRIPTION OF THE INVENTION

Certain rhamnolipids are known to have anti-microbial activity, but they are generally used as surfactants in cleansing compositions such as shampoos, body washes and laundry detergents. Commercially available rhamnolipids for use in mass produced personal care compositions like shampoos, conditioners and body washes are primarily rhamno-di-lipids. That is, the rhamnolipid molecule has two lipid tails. It has now been surprisingly discovered that mono-lipid rhamnolipids provide better anti-microbial efficacy than their di-lipid counterparts and good lather.

Reference within the specification to “embodiment(s)” or the like means that a particular material, feature, structure and/or characteristic described in connection with the embodiment is included in at least one embodiment, optionally a number of embodiments, but it does not mean that all embodiments incorporate the material, feature, structure, and/or characteristic described. Furthermore, materials, features, structures and/or characteristics may be combined in any suitable manner across different embodiments, and materials, features, structures and/or characteristics may be omitted or substituted from what is described. Thus, embodiments and aspects described herein may comprise or be combinable with elements or components of other embodiments and/or aspects despite not being expressly exemplified in combination, unless otherwise stated or an incompatibility is stated.

All ingredient percentages described herein are by weight of the cosmetic composition, unless specifically stated otherwise, and may be designated as “wt %.” All ratios are weight ratios, unless specifically stated otherwise. All ranges are inclusive and combinable. The number of significant digits conveys neither a limitation on the indicated amounts nor on the accuracy of the measurements. All numerical amounts are understood to be modified by the word “about” unless otherwise specifically indicated. Unless otherwise indicated, all measurements are understood to be made at approximately 25° C. and at ambient conditions, where “ambient conditions” means conditions under about 1 atmosphere of pressure and at about 50% relative humidity. All numeric ranges are inclusive of narrower ranges, and delineated upper and lower range limits are interchangeable to create further ranges not explicitly delineated.

The compositions of the present invention can comprise, consist essentially of, or consist of, the essential components as well as optional ingredients described herein. As used herein, “consisting essentially of” means that the composition or component may include additional ingredients, but only if the additional ingredients do not materially alter the basic and novel characteristics of the claimed compositions or methods. As used in the description and the appended claims, the singular forms “a,” “an,” and “the” are intended to include the plural forms as well, unless the context clearly indicates otherwise.

### Definitions

“About” modifies a particular value by referring to a range of plus or minus 20% or less of the stated value (e.g., plus or minus 15% or less, 10% or less, or even 5% or less).

“Apply” or “application,” as used in reference to a composition, means to apply or spread the composition onto a human keratinous surface such as the skin or hair.

“Aqueous” means a composition or material contains 30% or more water (more than 35%, 40%, 45%, 50%, 60%, 70%, 80%, 90% or even 100%), based on the weight of the composition or material.

“Personal care composition” is meant a product, which in the ordinary course of usage is applied to or contacted with a body surface to provide a beneficial effect such as, for example, improving appearance, cleansing, and odor control. Body surface includes skin, hair, teeth, or nails. Some non-limiting examples of personal care compositions include oral care compositions, (e.g., dentifrice, mouth rinse, mouth spray, lozenge, chewable tablet, chewing gum, teeth whitening strips, floss and floss coatings, breath freshening dissolvable strips, denture care products, and denture adhesive products), shave care compositions (e.g., after shave gels and creams, pre-shave preparations, shaving gels, creams), cough and cold compositions, leave-on skin lotions and creams, shampoos, body washes, hair conditioners, hair dyeing and bleaching compositions, styling mousses, shower gels, bar soaps, hand soaps, antiperspirants, deodorants, depilatories, lipsticks, foundations, mascara, sunless tanners and sunscreen lotions, feminine care compositions and absorbent articles, baby care compositions and absorbent articles.

“Cleansing composition” refers to a personal care composition intended for use in cleaning a bodily surface. Some non-limiting examples of cleansing compositions are shampoos, conditioners, conditioning shampoos, shower gels, liquid hand cleansers, facial cleansers, and the like.

“Anti-microbial” means a material that prevents or inhibits the growth of microorganisms (e.g., bacteria or fungi) in a product.

“Substantially free of”' means a composition or ingredient comprises less than 3% of a subject material, by weight of the composition or ingredient (e.g., less than 2%, less than 1% or even less than 0.5%). “Free of” means a composition or ingredient contains 0% of a subject material.

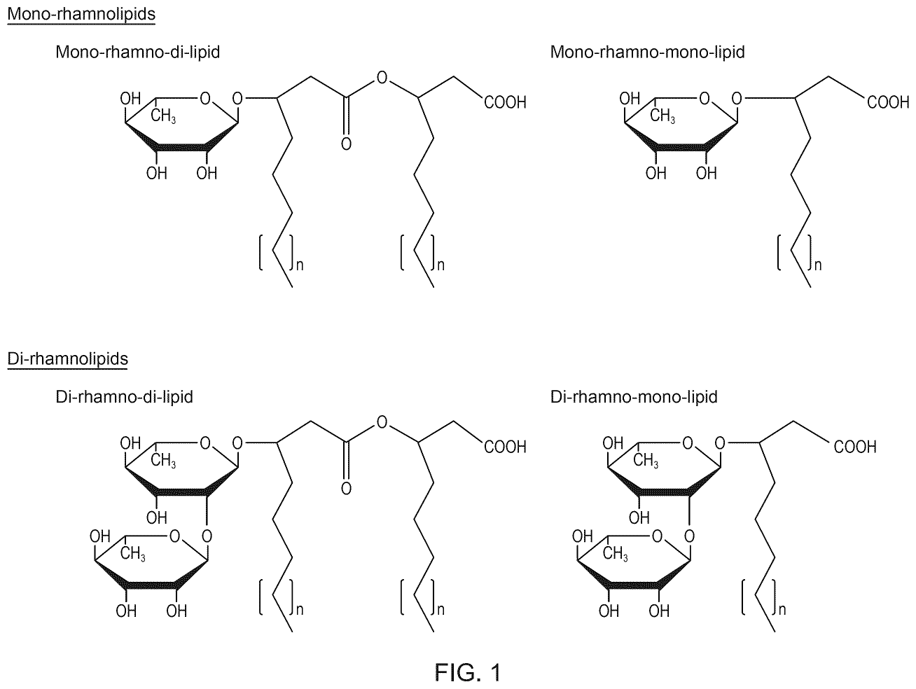

The anti-microbial system herein includes a rhamnolipid. Rhamnolipids are a class of glycolipid that have a glycosyl head group (rhamnose), and a fatty acid tail (lipid). There are two main classes of rhamnolipids: mono-rhamnolipids and di-rhamnolipids, which consist of one or two rhamnose head groups, respectively. Rhamnolipids have either one or two lipid tails, creating, for example, the molecules shown in FIG. 1. The rhamnolipids herein may be suitable for use as an anti-microbial system in personal care compositions, laundry compositions, hard surface cleaners, air fresheners, sunscreen products, insect control products, nutritional supplements and food additives. The rhamnolipid anti-microbial system herein may be particular suitable for use in aqueous compositions, for example, where it can serve a multifunctional role as a surfactant and an anti-microbial agent.

The anti-microbial system herein includes a mixture of mono-rhamno-mono-lipid and di-rhamno-mono-lipid, and may include other optional ingredients, as long as the optional ingredients do not undesirably interfere with the intended function of the rhamnolipid. In some instances, the anti-microbial system may include a beta hydroxy fatty acid, which can be a byproduct in certain fermentation processes used to make the rhamnolipids. The rhamnolipids herein can be produced by microorganisms (e.g., Pseudomonas aeruginosa, Pseudomonas putida, Pseudomonas chlororaphis). Methods of extracting and blending naturally produced rhamnolipids are known in the art.

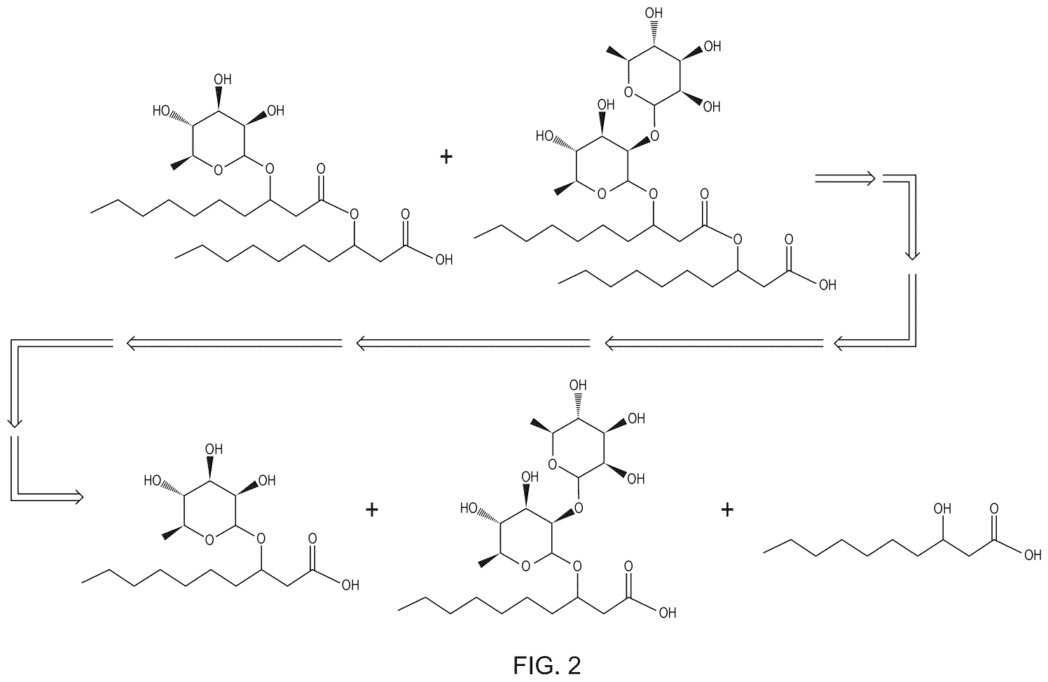

In some instances, the rhamnolipid mixture herein can be made using a semi-synthetic approach that involves performing a base hydrolysis on a di-rhamno-di-lipid compound (e.g., Rheance® One brand rhamnolipids from Evonik Industries AG, Essen, Germany). Possible bases include sodium hydroxide (NaOH), potassium hydroxide (KOH), calcium hydroxide (Ca(OH)₂), cesium hydroxide (CsOH), magnesium hydroxide (Mg(OH)₂), ammonium hydroxide (NH₄OH), and alkylamine containing bases such as triethylamine (Et₃N). A semi-synthetic approach is exemplified in FIG. 2.

The rhamno-mono-lipids resulting from hydrolysis of a di-rhamno-di-lipid species may include 25% or more, by the total weight of the rhamnolipids, of rhamno-mono-lipids (e.g., greater than or equal to 30%, 35%, 40%, 45%, 50%, 55%, 60%, 65%, 70%, 75%, 80%, 85%, 90%, 95%, 96%, 97%, 98%, 99%, or even 100%). These exemplary amounts of rhamno-mono-lipid species may be any combination of di-rhamno-mono-lipid and mono-rhamno-mono-lipid species, including only a single species of rhamno-mono-lipid.

The reaction product of di-rhamno-di-lipid hydrolysis may be free of or substantially free of di-lipids (i.e., di-rhamno-di-lipids and mono-rhamno-di-lipids). In other words, the hydrolysis reaction may completely convert the di-lipid starting material to mono-lipid species.

In some instances, the di-lipid compounds may not be completely hydrolyzed, and it may be desirable to remove the di-lipid species using conventional methods known in the art. The total amount of di-lipids present in the anti-microbial system herein is less than 25% (e.g., less than 20%, 15%, 10%, 5% 3% or even 0%), based on the total weight of the rhamnolipids.

The reaction product of the hydrolysis of the di-rhamno-di-lipid compounds includes compounds (a), (b) and (c), and all stereo isomers thereof, as shown below:

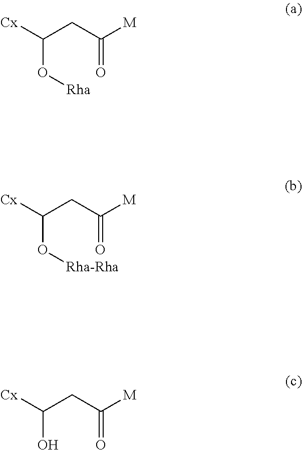

wherein Rha is rhamnose;
wherein each Cx is independently selected from an alkyl, aryl, heteroalkyl, heteroaryl, unsaturated alkenyl, and unsaturated heteroalkenyl;
wherein each Cx independently has a carbon chain length from 4 to 22 -(e.g., 5 to 13, 10 or 12);
wherein each M is independently selected from OH; O—X+ wherein X+ is a cation; OR1; alkyl, heteroalkyl; aryl; heteroaryl; hetero arylalkyl; arylalkyl; and tauryl;
wherein R1 is selected from an alkyl, branched alkyl, and cyclic alkyl. Some nonlimiting examples of mono-rhamno mono-lipid that may be suitable for use herein include 3-(((2R,3R,4R,5R,6S)-3,4,5-trihydroxy-6-methyltetrahydro-2H-pyran-2-yl)oxy)hexadecanoic acid, 3-(((2R,3R,4R,5R,6S)-3,4,5-trihydroxy-6-methyltetrahydro-2H-pyran-2-yl)oxy)octenoic acid, 3-(((2R,3R,4R,5R,6S)-3,4,5-trihydroxy-6-methyltetrahydro-2H-pyran-2-yl)oxy)decenoic acid, 3-(((2R,3R,4R,5R,6S)-3,4,5-trihydroxy-6-methyltetrahydro-2H-pyran-2-yl)oxy)octanoic acid, 3-(((2R,3R,4R,5R,6S)-3,4,5-trihydroxy-6-methyltetrahydro-2H-pyran-2-yl)oxy)tetradecanoic acid, 3-(((2R,3R,4R,5R,6S)-3,4,5-trihydroxy-6-methyltetrahydro-2H-pyran-2-yl)oxy)decanoic acid, 3-(((2R,3R,4R,5R,6S)-3,4,5-trihydroxy-6-methyltetrahydro-2H-pyran-2-yl)oxy)dodecanoic acid, 3-(((2R,3R,4R,5R,6S)-3,4,5-trihydroxy-6-methyltetrahydro-2H-pyran-2-yl)oxy)dodecen-dienoic acid, and stereoisomers thereof.

Some non-limiting examples of di-rhamno mono-lipid that may be suitable for use herein include 3-(((2R,3R,4R,5R,6S)-4,5-dihydroxy-6-methyl-3-(((2R,3S,4S,5S,6S)-3,4,5-trihydroxy-6-methyltetrahydro-2H-pyran-2-yl)oxy)tetrahydro-2H-pyran-2-yl)oxy)hexadecanoic acid, 3-(((2R,3R,4R,5R,6S)-4,5-dihydroxy-6-methyl-3-(((2R,3S,4S,5S,6S)-3,4,5-trihydroxy-6-methyltetrahydro-2H-pyran-2-yl)oxy)tetrahydro-2H-pyran-2-yl)oxy)tetradecanoic acid, 3-(((2R,3R,4R,5R,6S)-4,5-dihydroxy-6-methyl-3-(((2R,3S,4S,5S,6S)-3,4,5-trihydroxy-6-methyltetrahydro-2H-pyran-2-yl)oxy)tetrahydro-2H-pyran-2-yl)oxy)decenoic acid, 3-(((2R,3R,4R,5R,6S)-4,5-dihydroxy-6-methyl-3-(((2R,3S,4S,5S,6S)-3,4,5-trihydroxy-6-methyltetrahydro-2H-pyran-2-yl)oxy)tetrahydro-2H-pyran-2-yl)oxy)tetradecenoic acid, 3-(((2R,3R,4R,5R,6S)-4,5-dihydroxy-6-methyl-3 -(((2R,3S,4S,5S,6S)-3,4,5-trihydroxy-6-methyltetrahydro-2H-pyran-2-yl)oxy)tetrahydro-2H-pyran-2-yl)oxy)decanoic acid, 3-(((2R,3R,4R,5R,6S)-4,5-dihydroxy-6-methyl-3-(((2R,3S,4S,5S,6S)-3,4,5-trihydroxy-6-methyltetrahydro-2H-pyran-2-yl)oxy)tetrahydro-2H-pyran-2-yl)oxy)octanoic acid, and 3-(((2R,3R,4R,5R,6S)-4,5-dihydroxy-6-methyl-3-(((2R,3S,4S,5S,6S)-3,4,5-trihydroxy-6-methyltetrahydro-2H-pyran-2-yl)oxy)tetrahydro-2H-pyran-2-yl)oxy)dodecanoic acid, and stereoisomers thereof.

Examples of methods for making rhamno-mono-lipids are disclosed in U.S. Ser. Nos. 63/558,670, 63/557,812 and 63/641,630.

Aqueous carrier

In some aspects, the rhamnolipid anti-microbial system may be mixed with a suitable carrier to form an anti-microbial composition. The level and species of the carrier can be selected according to the compatibility with other components, and other desired characteristic of the product to which the anti-microbial composition may be added. The carrier may include water (e.g., an aqueous carrier) and/or water miscible liquids such as lower alkyl alcohols. The lower alkyl alcohols can be monohydric alcohols having 1 to 6 carbons. The carrier may be present at 10% to 95% based on the weight of the anti-microbial composition. Of course, it is to be appreciated that the anti-microbial composition may consist of or consist essentially of components (a), (b) and, optionally, (c) described above.

### Additional Components

Anti-microbial compositions herein may optionally include additional components, such as, for example, other anti-microbial agents, active agents for providing a benefit to a target surface (e.g., skin, hair, teeth, fabric, or hard surface), surfactants, humectants, emollients, thickeners, fragrances, stabilizers, colorants, pH adjustors, chelants and antioxidants. Such agents and the amounts in which they may be incorporated would be known to those of ordinary skill in the art. For example, the additional ingredient may be present at 0.1% to 30% (e.g., 0.5% to 25%, 1% to 20%, 3% to 15%, or 5% to 10%).

In some aspects, the anti-microbial composition is free of or substantially free of ingredients (other anti-microbial agents or optional ingredients) that do not meet a particular sustainability standard or naturally derived ingredient standard such as, for example, EWG VERIFIED™, Whole Foods® unacceptable ingredients list, and “risk-free” (green dot) by the Yuka® Application. Some non-limiting examples of anti-microbial agents that may not be suitable include isothiazolinones (e.g., 5-chloro-2-methyl-4-isothiazolin-3-one and 2-methyl- 4-isothiazolin-3-one, commercially available as Kathon™ CG from Dow®), benzyl alcohol, phenoxyethanol, cyclohexylglycerin, parabens, and ethylenediaminetetraacetic acid (EDTA) and salts thereof.

### METHODS

### Minimal Kill Concentration (MKC)

The MKC assay is a 96 well plate method to determine the minimum concentration of a test material or composition needed to kill Gram-negative and Gram-positive bacteria (Escherichia coli ATCC 8739 and Staphylococcus aureus ATCC 6538, respectively).

The bacterial suspensions are prepared from 10× freezer stocks with 15% glycerol. The freezer stocks are centrifuged at ˜13,000×g (Eppendorf Centrifuge 5417C No. 5417 05483) for 1 minute. The supernatant is removed, and the cell pellet is resuspended in 1 mL saline (Sodium chloride solution 0.9%, Cytiva REF: Z1376), and then transferred to 9 mL saline. The target cfu/ml is 10^8, which is confirmed via serial diluting and plating on TSA plates (Tryptic Soy Agar—Sigma-Aldrich Cat #22091). Then 50 μL of bacteria is added to each well of a 96 well 0.5 mL V-Bottom plate (Greiner bio-one REF: 786201) to make a bacteria plate, one separate plate for each bacterium.

The dilutions of the test compounds are prepared in a separate 96 well plate. The test compounds are tested at six dilutions in duplicates or with no replication diluted across the entire plate. The test compounds are prepared in Dimethyl Sulfoxide (Sigma Aldrich GR ACS Cat. No: MX1458-6) or sterile water at 2× the intended test concentration, and then serially diluted in the appropriate vehicle 1:2 across the plate using a multichannel. 50 μL from the test compound plate is added to each well in the bacteria plate all at once using an Integra VIAFLOW 96 channel pipette (Model: VIAFLO 96) and the Integra 300 μL Head (Part No. 6103). With addition of the 2× compounds bacteria plate, the compounds are diluted to a 1× test concentration. The addition of the test compounds to the bacteria wells starts the 20-minute contact time. The plates are mixed well using a Mix-Mate (Eppendorf SE).

After 20 minutes, 1 μL from each well of the bacteria plate is transferred to premade Tryptic Soy Agar (TSA) plates (OmniTray Cell Culture Treated w/Lid Sterile, Cat. No: 165218) for spot plating using the Integra VIAFLOW 96 with the Integra 12.5 μL head (Part No. 6101). Then 4 μL from each well of the bacteria/compound plate is transferred to another 96 well plate containing 36 μL of neutralizer broth Modified Letheen Broth (BD Difco Letheen Broth, Modified REF 263010). The contact time is stopped at 20 minutes once the compound plate is neutralized. The plates are mixed well using a Mix-Mate and then 1 μL of the neutralizer+sample mix is transferred to a TSA OmniTray plate using the Integra VIAFLOW and Integra 12.5 μL head. The TSA spot plates are then incubated overnight for 20 hours at 37° C. in an Incubator. This process is done for both bacteria species.

After overnight incubation, the plates are removed from the incubator and the results recorded by observing which dilutions had bacterial kill/growth. The last dilution that had kill for both replicates is recorded as the MKC.

A positive control of Benzalkonium chloride (Sigma Aldrich Cat. No.: 12060-5G) and vehicle controls are always included in the test.

### Minimum Inhibitory Concentration (MIC)

The Minimum Inhibitory Concentration (MIC) assay is a 96-well high throughput method that determines the minimum concentration of an active required to inhibit the growth of microorganisms.

### Organism Preparation

Compounds are evaluated against the following microorganisms: Staphylococcus aureus ATCC #6538 (American Type Culture Collection, Manassas, Virginia, USA). To prepare solutions, the bacteria are streaked on Tryptic Soy Agar (TSA, Becton Dickinson DIFCO™ Tryptic Soy Agar, Franklin Lakes, NJ, USA) and incubated at 30-35° C. for 18-24 hrs. Confluent growth is transferred to saline (0.85% NaCl and turbidometrically adjusted to a target concentration of 10⁷-10⁸ CFU/ml. This inoculum solution is further diluted 1:1000 in Tryptic Soy Broth (TSB, Becton Dickinson, Franklin Lakes, NJ, USA) for assay use.

### Assay:

Two-fold serial dilutions are prepared in Dimethylsulfoxide (DMSO, Thermo Scientific Pierce DMSO, Sequencing Grade) or sterile water for each test sample. In a sterile 96-well plate, each dilution is further diluted in broth inoculum such that each well contained 5% dilution and 95% broth inoculum. Bacteria and yeast plates were incubated on an orbital shaker (Heidolph Titramax 1000 Vibrating Platform Shaker, 200-300 rpm) for 24±2 hrs at 35° C. After incubation, the optical density (OD) of each well is measured in a spectrophotometer (Victor Nivo Multimode Plate Reader) at 600 nm. The MIC is determined as the most dilute well with an OD<50% compared to a growth control (≥50% inhibition). To determine the Minimum Biocidal Concentration (MBC), 2 ul from each well is pipetted onto neutralizing agar (Modified Letheen Agar with 1.5% Tween 80 (polysorbate 80)) and incubated for 24 hours at 30-35° C. The MBC was determined as the most dilute concentration with no visible growth.

### Ultra High-Performance Liquid Chromatography—Charged Aerosol Detector (UPLC-CAD)

Chromatography is conducted on an ACQUITY BEH C18 Vanguard precolumn (130Å, 1.7 μm, 2.1 mm×5 mm (available Waters, Milford, MA, USA)) or equivalent, followed by an ACQUITY UPLC BEH C18 Column (130Å, 1.7 μm, 2.1 mm×100 mm, (Waters, Milford, MA, USA)) or equivalent. The LC gradient is carried out on Vanquish UPLC-CAD system (Thermo Fisher Scientific, Waltham, MA, USA) from 5 to 95% B (Acetonitrile) over 10.5 min, for a total run time of 15 min with inverse gradient. Mobile Phase A is 4 mM Ammonium Acetate in Water, and the flow rate is set to 0.4 mL/min. The column temperature is kept at 45° C. in the column compartment. All data processing is performed using the Xcalibur® brand data acquisition and interpretation software (available from Thermo Fisher Scientific) or equivalent.

The peak identity for rhamnolipids is confirmed by LC-MS/MS (liquid chromatography (LC) tandem mass spectrometry (MS). Eluted rhamnolipids from the UPLC column are analyzed by tandem mass spectrometry on a Triple Quad 6500+ system (AB Sciex, Framingham, MA, USA) or equivalent. The instrument is operated in multiple reaction monitoring (MRM) and negative electrospray ionization (ESI) mode. Data processing is performed using Skyline® Software, Version 23.1.0.268 (MacCoss Lab, University of Washington, Seattle, WA, USA) or equivalent. For relative quantitation purpose, carbon-13 stable isotope labeled Rhamnolipids are prepared by fermentation using D-glucose (U-13C6) as the sole carbon source. The list of rhamnolipids and corresponding transitions is included.

### EXAMPLES

### Example 1. Synthesis of rhamno-mono-lipid

A 2L, 3-neck round-bottomed flask was equipped with reflux condenser with N2 inlet regulator, Caframo RZR-2000 Overhead Stirrer, and J-Kem Scientific Temperature Controller with probe. The flask was charged with 500 grams of Rheance® One rhamnolipid surfactant from Evonik, (50% weight in H₂O, 250 g, Mw˜683, 0.37 mol), followed by 30 g of NaOH pellets (CAS 1310-73-2). The solution was heated to 90° C. and stirred for 3 hours. Next, the solution was cooled to room temperature and then lyophilized at 130 mTorr for 72 hrs using a Virtis Model #50L Virtual XL-70 lyophilizer (0° C.—room temperature shelf temperature).

The result of the hydrolysis was a reddish, tacky solid (230 grams). The resulting material was analyzed using standard analytical methods to identify the compounds that were present. The compounds identified in the sample are shown in Table 1.

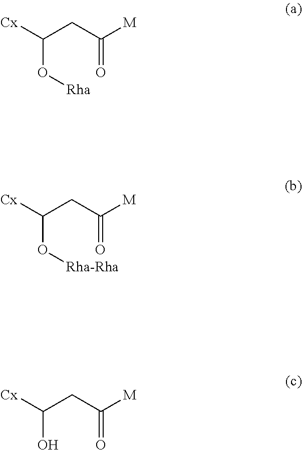

TABLE 1

| Structure A | Structure B | Structure C | Chemical Name |
|---|---|---|---|
| | | 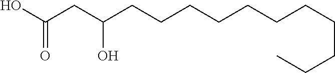 [SMILES: CCCCCCCCCCCC(O)CC(=O)O] 3-hydroxytetradecanoic acid | 3-hydroxytetradecanoic acid |
| | | 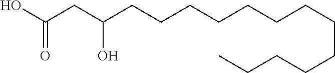 [SMILES: CCCCCCCCCCCCCC(O)CC(=O)O] | 3-hydroxyhexadecanoic acid |
| | | 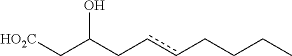 | 3-hydroxydeceneoic acid |
| | | 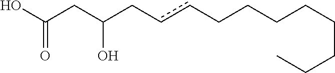 | 3-hydroxytetradecenoic acid |
| | | 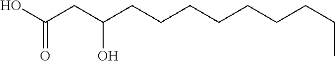 | 3-hydroxydodecanoic acid |
| | 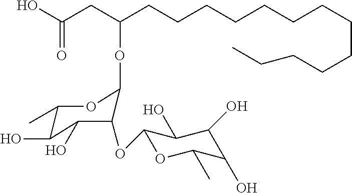 [SMILES: CCCCCCCCCCCCCC(CC(=O)O)OC1OC(C)C(O)C(O)C1OC1OC(C)C(O)C(O)C1O] | | 3-(((2R,3R,4R,5R,6S)-4,5- dihydroxy-6-methyl-3- (((2R,3S,4S,5S,6S)-3,4,5- trihydroxy-6-methyltetrahydro- 2H-pyran-2-yl)oxy)tetrahydro- 2H-pyran-2-yl)oxy)hexadecanoic acid |
| | 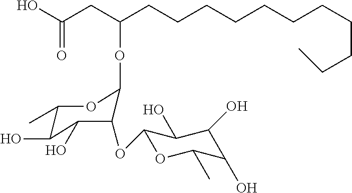 [SMILES: CCCCCCCCCCCC(CC(=O)O)OC1OC(C)C(O)C(O)C1OC1OC(C)C(O)C(O)C1O] | | 3-(((2R,3R,4R,5R,6S)-4,5- dihydroxy-6-methyl-3- (((2R,3S,4S,5S,6S)-3,4,5- trihydroxy-6-methyltetrahydro- 2H-pyran-2-yl)oxy)tetrahydro- 2H-pyran-2-yl)oxy)tetradecanoic acid |
| | | 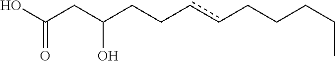 | 3-hydroxydodecenoic acid |
| | 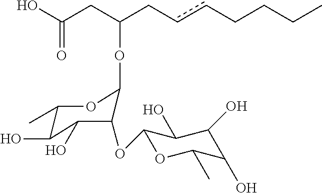 | | 3-(((2R,3R,4R,5R,6S)-4,5- dihydroxy-6-methyl-3- (((2R,3S,4S,5S,6S)-3,4,5- trihydroxy-6-methyltetrahydro- 2H-pyran-2-yl)oxy)tetrahydro- 2H-pyran-2-yl)oxy)decenoic acid |
| | | 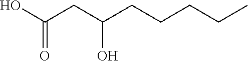 | 3-hydroxyoctanoic acid |
| 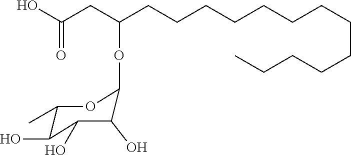 [SMILES: CCCCCCCCCCCCCC(CC(=O)O)OC1OC(C)C(O)C(O)C1O] | | | 3-(((2R,3R,4R,5R,6S)-3,4,5- trihydroxy-6-methyltetrahydro- 2H-pyran-2-yl)oxy)hexadecanoic acid |
| 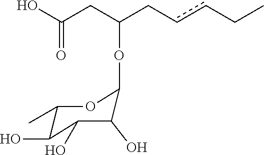 | | | 3-(((2R,3R,4R,5R,6S)-3,4,5- trihydroxy-6-methyltetrahydro- 2H-pyran-2-yl)oxy)octenoic acid |
| | | 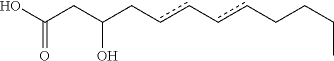 | 3-hydroxydodec-dienoic acid |
| | 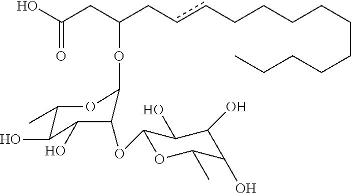 | | 3-(((2R,3R,4R,5R,6S)-4,5- dihydroxy-6-methyl-3- (((2R,3S,4S,5S,6S)-3,4,5- trihydroxy-6-methyltetrahydro- 2H-pyran-2-yl)oxy)tetrahydro- 2H-pyran-2-yl)oxy)tetradecenoic acid |
| | 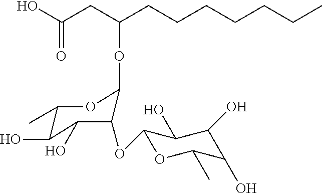 [SMILES: CCCCCCCC(CC(=O)O)OC1OC(C)C(O)C(O)C1OC1OC(C)C(O)C(O)C1O] | | 3-(((2R,3R,4R,5R,6S)-4,5- dihydroxy-6-methyl-3- (((2R,3S,4S,5S,6S)-3,4,5- trihydroxy-6-methyltetrahydro- 2H-pyran-2-yl)oxy)tetrahydro- 2H-pyran-2-yl)oxy)decanoic acid |
| 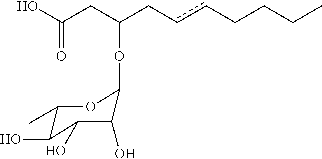 | | | 3-(((2R,3R,4R,5R,6S)-3,4,5- trihydroxy-6-methyltetrahydro- 2H-pyran-2-yl)oxy)decenoic acid |
| | 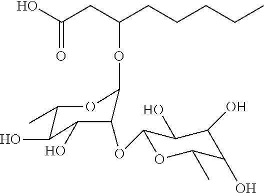 [SMILES: CCCCCC(CC(=O)O)OC1OC(C)C(O)C(O)C1OC1OC(C)C(O)C(O)C1O] | | 3-(((2R,3R,4R,5R,6S)-4,5- dihydroxy-6-methyl-3- (((2R,3S,4S,5S,6S)-3,4,5- trihydroxy-6-methyltetrahydro- 2H-pyran-2-yl)oxy)tetrahydro- 2H-pyran-2-yl)oxy)octanoic acid |
| | 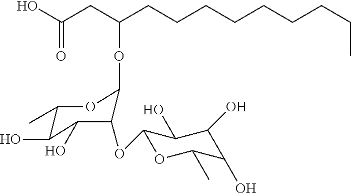 [SMILES: CCCCCCCCCC(CC(=O)O)OC1OC(C)C(O)C(O)C1OC1OC(C)C(O)C(O)C1O] | | 3-(((2R,3R,4R,5R,6S)-4,5- dihydroxy-6-methyl-3- (((2R,3S,4S,5S,6S)-3,4,5- trihydroxy-6-methyltetrahydro- 2H-pyran-2-yl)oxy)tetrahydro- 2H-pyran-2-yl)oxy)dodecanoic acid |
| 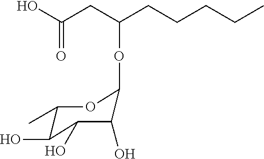 [SMILES: CCCCCC(CC(=O)O)OC1OC(C)C(O)C(O)C1O] | | | 3-(((2R,3R,4R,5R,6S)-3,4,5- trihydroxy-6-methyltetrahydro- 2H-pyran-2-yl)oxy)octanoic acid |
| 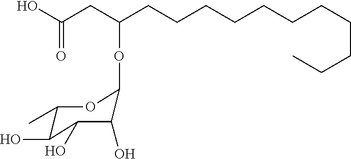 [SMILES: CCCCCCCCCCCC(CC(=O)O)OC1OC(C)C(O)C(O)C1O] | | | 3-(((2R,3R,4R,5R,6S)-3,4,5- trihydroxy-6-methyltetrahydro- 2H-pyran-2-yl)oxy)tetradecanoic acid |
| | | 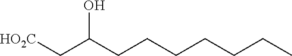 | 3-hydroxydecaneoic acid |
| 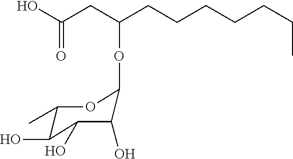 [SMILES: CCCCCCCC(CC(=O)O)OC1OC(C)C(O)C(O)C1O] | | | 3-(((2R,3R,4R,5R,6S)-3,4,5- trihydroxy-6-methyltetrahydro- 2H-pyran-2-yl)oxy)decanoic acid |
| 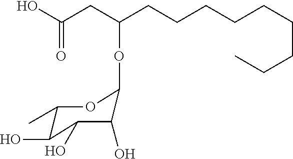 [SMILES: CCCCCCCCCC(CC(=O)O)OC1OC(C)C(O)C(O)C1O] | | | 3-(((2R,3R,4R,5R,6S)-3,4,5- trihydroxy-6-methyltetrahydro- 2H-pyran-2-yl)oxy)dodecanoic acid |
| 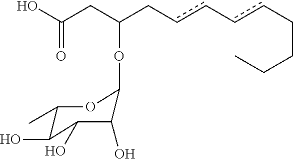 | | | 3-(((2R,3R,4R,5R,6S)-3,4,5- trihydroxy-6-methyltetrahydro- 2H-pyran-2-yl)oxy)dodecen- dienoic acid |

The starting material (Rheance® One rhamnolipid surfactant) and the hydrolyzed inventive material were subjected to mass spectroscopy. The results are shown in Table 2. A rhamnose group is represented as (Rha) and a lipid abbreviated as Cn or Cn: m (where n=number of carbon atoms; m=number of unsaturation). ND =not detected. % Difference of molecule post hydrolysis=(AUC post hydrolysis)/(AUC before hydrolysis) *100.

After hydrolysis, the rhamno-mono-lipid species detection increased between 184% and 1092%. In some cases, new rhamno-mono-lipid molecules were detected. The rhamno-di-lipid were completely hydrolyzed (not detected) or detected at very low and insignificant amounts, i.e. 0.6-24%. Thus, the rhamnolipids herein contain a high amount of rhamno-mono-lipids compared to commercially available rhamnolipids.

TABLE 2

| | | | | % Difference of |
|---|---|---|---|---|
| Rhamnolipid | | AUC (Pre- | AUC (Post- | molecule post |
| Class | Molecule | hydrolysis) | hydrolysis) | hydrolysis |
| Mono-rhamno- | Rha-C8 | 1063249 | 3813199 | 358.636 |
| mono-lipid | Rha-C10 | ND | 8606355 | New molecule |
| | Rha-C12 | 537716 | 993329 | 184.731 |
| | Rha-C12:1 | 15662 | ND | ND |
| | Rha-C14:1 | ND | 161875 | New molecule |
| Di-rhamno- | RhaRha-C8 | 24485006 | 100543784 | 410.634 |
| mono-lipid | RhaRha-C10 | 173099952 | 807753664 | 466.640 |
| | RhaRha-C10:1 | 255899 | 2795532 | 1092.436 |
| | RhaRha-C12 | 15592295 | 101665328 | 652.023 |
| | RhaRha-C12:1 | ND | 14508326 | New Molecule |
| | RhaRha-C14 | 700558 | 5241753 | 748.225 |
| | RhaRha-C14:1 | 2420763 | 15934095 | 658.226 |
| | RhaRha-C16 | 62651 | 540257 | 862.328 |
| Mono-rhamno- | Rha-C8C8 | 4988452 | ND | ND |
| di-lipid | Rha-C8C10 | 125784560 | 727010 | 0.578 |
| | Rha-C8C10:1 | 51561 | ND | ND |
| | Rha-C8C12 | 422537 | ND | ND |
| | Rha-C9C10 | 400385 | ND | ND |
| | Rha-C10:1C8 | 633840 | ND | ND |
| | Rha-C10:1C10 | 1555974 | ND | ND |
| | Rha-C10C8 | 174208176 | 865146 | 0.497 |
| | Rha-C10C9 | 701084 | ND | ND |
| | Rha-C10C10 | 313724128 | ND | ND |
| | Rha-C10C10:1 | 372849 | ND | ND |
| | Rha-C10C11 | 201062 | ND | ND |
| | Rha-C10C12 | 15347609 | 463631 | 3.021 |
| | Rha-C10C12:1 | 844589 | ND | ND |
| | Rha-C10C14 | 816377 | 68528 | 8.394 |
| | Rha-C10C14:1 | 3160281 | ND | ND |
| | Rha-C10C16 | 27411 | ND | ND |
| | Rha-C11C10 | 366337 | ND | ND |
| | Rha-C12:1C8 | 2439149 | ND | ND |
| | Rha-C12:1C10 | 25018042 | 865093 | 3.458 |
| | Rha-C12:1C12 | 1291091 | ND | ND |
| | Rha-C12:1C12:1 | 325098 | ND | ND |
| | Rha-C12C8 | 2900004 | ND | ND |
| | Rha-C12C10 | 30280874 | ND | ND |
| | Rha-C12C12 | 832122 | 201085 | 24.165 |
| | Rha-C12C12:1 | 57431 | ND | ND |
| | Rha-C12C14:1 | 99859 | ND | ND |
| | Rha-C14:1C10 | 2865155 | ND | ND |
| Di-rhamno-di- | RhaRha-C8C8 | 151578208 | 1418875 | 0.936 |
| lipid | RhaRha-C8C10 | 963405120 | 82897920 | 8.605 |
| | RhaRha-C8C12 | 40224272 | 6429435 | 15.984 |
| | RhaRha-C8C12:1 | 278139456 | 6011257 | 2.161 |
| | RhaRha-C10:1C10 | 207076368 | 2935456 | 1.418 |
| | RhaRha- | 1107927 | ND | ND |
| | C10:1C12:1 | | | |
| | RhaRha-C10C8 | 1004911808 | 94418816 | 9.396 |
| | RhaRha-C10C10 | 3263549696 | 788014272 | 24.146 |
| | RhaRha-C10C10:1 | 166241424 | 2550719 | 1.534 |
| | RhaRha-C10C12 | 951596352 | 124517272 | 13.085 |
| | RhaRha-C10C12:1 | 1158122496 | 104077520 | 8.987 |
| | RhaRha-C10C14 | 124723464 | 7578224 | 6.076 |
| | RhaRha-C10C14:1 | 361702752 | 22878010 | 6.325 |
| | RhaRha-C12:1C8 | 217275888 | 3790275 | 1.744 |
| | RhaRha-C12:1C10 | 1297265280 | 89493808 | 6.899 |
| | RhaRha-C12:1C12 | 143677024 | 3808457 | 2.651 |
| | RhaRha- | 26095004 | 1152989 | 4.418 |
| | C12:1C12:1 | | | |
| | RhaRha-C12C8 | ND | 6449920 | New Molecule |
| | RhaRha-C12C10 | 1211309824 | 150630688 | 12.435 |
| | RhaRha-C12C12 | 132062784 | 6477482 | 4.905 |
| | RhaRha-C12C12:1 | 155098160 | 3873338 | 2.497 |
| | RhaRha-C12C14 | 7439984 | 346153 | 4.653 |
| | RhaRha-C14:1C10 | 351906432 | 17409038 | 4.947 |
| | RhaRhaC14C10 | 136522384 | 6874241 | 5.035 |

Tables 3A and Table 3B show the weight percentage of some of the species from Table 2 that were found in the mass spectroscopy of the post-hydrolysis material (Table 3A) and the weight percentages of the species pre-and post-hydrolysis (Table 3B). The data shown in Tables 3A and 3B was obtained using UPLC-CAD with a retention time (RT) of 2 to 12 minutes. The data in Table 3A suggest that about 78.2% of the post-hydrolysis material is rhamno-mono-lipid.

TABLE 3A

| RT | Area | Wt. % | Analyte | |
|---|---|---|---|---|
| 2.89 | 0.116 | 0.28 | | |
| 3.04 | 4.266 | 10.26 | RhaRhaC8 | |
| 3.18 | 0.019 | 0.05 | | |
| 3.57 | 0.02 | 0.05 | | |
| 4.09 | 27.021 | 64.97 | RhaRhaC10 | |
| 4.18 | 0.464 | 1.12 | RhaC10 | |
| 4.45 | 0.755 | 1.82 | C10 | |
| 4.56 | 0.019 | 0.05 | | |
| 4.70 | 0.073 | 0.18 | | |
| 5.02 | 0.476 | 1.14 | RhaRhaC12 | |
| 5.21 | 0.258 | 0.62 | RhaC12 | |
| 5.45 | 0.027 | 0.06 | | |
| 5.50 | 0.023 | 0.06 | RhaRhaC14:1 | |
| 5.66 | 0.261 | 0.63 | C12 | |
| 6.18 | 0.046 | 0.11 | C14:1 | RhaRhaC14 |
| 6.47 | 0.263 | 0.6 | RhaRhaC10C8 | RhaRhaC8C10 |
| 6.91 | 0.017 | 0.04 | | |
| 7.26 | 1.864 | 4.48 | RhaRhaC10C10 | |
| 7.75 | 0.082 | 0.20 | RhaRhaC12:1C10 | RhaRhaC10C12:1 |
| 7.87 | 0.034 | 0.08 | C10C10 | |
| 8.14 | 0.155 | 0.37 | RhaRhaC12C10 | RhaRhaC10C12 |
| 8.30 | 0.612 | 1.47 | | |
| 9.49 | 4.181 | 10.05 | RhaC12C12 | |
| 9.91 | 0.19 | 0.46 | C12C12 | |
| 10.66 | 0.316 | 0.76 | RhaC12C14 | RhaC14C12 |
| 11.96 | 0.031 | 0.07 | | |

Table 3B shows a comparison of the weight percent of rhamno-mono-lipids and rhamno-di-lipids pre-and post-hydrolysis. As can be seen, the inventive composition comprises a much higher amount of rhamnomonolipid material.

TABLE 3B

| | |
|---|---|
| Pre-hydrolysis | Post-hydrolysis |
| (Rheance ® | (inventive |
| One): | material): |

Wt %

| | | |
|---|---|---|
| Rhamnomonolipids | 3.6 | 78.2 |
| Rhamnodilipids | 94 | 16.5 |

### Example 2: Anti-Microbial Effect

This example demonstrates the anti-microbial effect of the inventive rhamnolipid mixture by comparing its ability to kill or inhibit the growth of Escherichia coli (E. coli) and Staphylococcus aureus (S. aureus) compared to a conventional rhamnolipid material.

Table 4 provides a summary of the results of the MKC assay, i.e., the minimum concentration needed to kill the subject microbe. As can be seen in Table 4, the inventive rhamnolipid mixture has a greater anti-microbial effect than the commercial rhamnolipid product. Similarly, individual mono-rhamno-mono-lipid species and individual beta hydroxy fatty acids, which are all in the hydrolyzed composition in greater amounts than they are in the commercial rhamnolipid, exhibit greater anti-microbial effect than the commercial rhamnolipid. This suggests that the inventive rhamnolipid mixture would provide a better anti-microbial benefit than current commercially available rhamnolipid materials.

The rhamnolipid mixture herein may exhibit an MKC against E. coli of less than 20,000 ppm (e.g., less than 19,000 ppm, 18,000 ppm, 17,000 ppm, 16,000 ppm, 15,000 ppm, 14,000 ppm or even less than 10,000 ppm) according to the MKC test method. In some embodiments, an inventive rhamnolipid mixture may have a minimal kill concentration against S. aureus of less than about 35,000 ppm, less than about 34,000 ppm, less than about 33,000 ppm, less than about 32,000 ppm, from about 25,000 ppm to about 35,000 ppm, from about 27,000 ppm to about 33,000 ppm, from about 29,000 ppm to about 32,000 ppm, or from about 31,000 ppm to about 32,000 ppm, as determined by the MKC assay.

Table 5 provides a summary of the results of the MIC assay for the same materials as listed in Table 4. As can be seen in Table 5, the inventive rhamnolipid mixture has a greater anti-microbial effect than the commercial rhamnolipid product, and the individual mono-rhamno-mono-lipid species and individual beta hydroxy fatty acids, which are all in the hydrolyzed composition in greater amounts than they are in the commercial rhamnolipid, exhibit greater anti-microbial effect than the commercial rhamnolipid.

The inventive rhamnolipid mixture herein may have an MIC against S. aureus of less than 100 ppm (e.g., less than 90 ppm, 80 ppm, 70 ppm, 60 ppm or even less than 50 ppm). according to the MIC assay.

TABLE 4

| | | | MKC (ppm) | |
|---|---|---|---|---|
| | Sample Name | Solvent | E. coli | S. aureus |
| Rheance ® One | Rhe | water | >100000 | >100000 |
| Inventive rhamnolipid | Rhe/NaOH | water | 25000 | 25000 |
| Monorhamnolipids | RhaC8 | water | >1225 | >1225 |
| | RhaC10 | water | >1338 | >1338 |
| | RhaC11 | water | 1394 | 1394 |
| | RhaC12 | water | >1450 | 725 |
| | RhaC13 | DMSO | 753 | 1506 |
| | RhaC14 | DMSO | 781 | 781 |
| beta hydroxy fatty | (±)-3- | water | >641 | >641 |
| acids | Hydroxyoctanoic | | | |
| | acid | | | |
| | (±)-3- | water | 753 | 753 |
| | Hydroxydecanoic | | | |
| | acid | | | |
| | (3R)-3- | water | >865 | 865 |
| | hydroxydodecanoic | | | |
| | acid | | | |
| | DL-β- | water | >865 | >865 |
| | Hydroxylauric acid | | | |
| | DL-β- | DMSO | 122 | 244 |
| | Hydroxymyristic | | | |
| | acid | | | |
| | DL-β- | DMSO | 136 | >1090 |
| | Hydroxypalmitic | | | |
| | acid | | | |

TABLE 5

| | | MIC | S. aureus | |
|---|---|---|---|---|
| | Sample Name | Solvent | MIC (ppm) | MBC (ppm) |
| commercial | Rhe | Water | 10000 | >10000 |
| rhamnolipid | | | | |
| (Rheance One) | | | | |
| hydrolyzed rhamnolipid | Rhe/NaOH | DMSO | 78 | 78 |
| (Example A Scheme 1) | | | | |
| monorhamnomonolipids | Rha1C8 | DMSO | 10000 | >10000 |
| | Rha1C10 | DMSO | >10000 | >10000 |
| | Rha1C11 | DMSO | 2500 | >10000 |
| | Rha1C12 | DMSO | 1250 | >10000 |
| | Rha1C13 | DMSO | 2500 | >10000 |
| | Rha1C14 | DMSO | 625 | >10000 |
| beta hydroxy fatty acids | (±)-3-Hydroxyoctanoic | | | |
| | acid | | | |
| | (±)-3-Hydroxydecanoic | DMSO | 1130 | >1130 |
| | acid | | | |
| | (3R)-3- | | | |
| | hydroxydodecanoic acid | | | |
| | DL-β-Hydroxylauric acid | DMSO | 325 | 650 |
| | DL-β-Hydroxymyristic | DMSO | 365 | 731 |
| | acid | | | |
| | DL-β-Hydroxypalmitic | DMSO | 102 | 204 |
| | acid | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An anti-microbial system, comprising:
a) a mono-rhamno, mono-lipid of structure I: 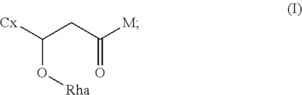
and
b) a di-rhamno, mono-lipid of structure II: 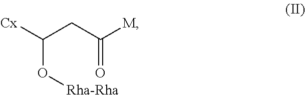
wherein:
Rha is rhamnose, Cx is a C4-C22 alkyl, aryl, heteroalkyl, heteroaryl, unsaturated alkenyl, or unsaturated heteroalkenyl, and
M is a OH, alkyl, heteroalkyl, aryl, heteroaryl, hetero arylalkyl, arylalkyl, tauryl, O—X+, wherein X+ is a cation, or O—R1, wherein R1 is selected from an alkyl, branched alkyl, and cyclic alkyl, and stereoisomers thereof.

2. The anti-microbial system of claim 1, wherein the anti-microbial system exhibits a minimum inhibitory concentration against S. aureus of less than 100 ppm, according to the Minimal Inhibitory Concentration method.

3. The anti-microbial system of claim 1, wherein the anti-microbial system exhibits a minimum kill concentration against E. coli of less than about 20,000 ppm according to the Minimal Kill Concentration Assay (MKCA).

4. The anti-microbial system of claim 1, wherein the anti-microbial system exhibits a minimum kill concentration against S. aureus of less than about 35,000 ppm, according to the MKCA.

5. The anti-microbial system of claim 1, further comprising a beta hydroxy fatty acid having a formula III:

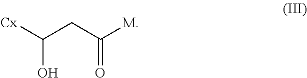

6. The anti-microbial system of claim 4, wherein the beta hydroxy fatty acid is selected from 3-hydroxytetradecanoic acid, 3-hydroxyhexadecanoic acid, 3-hydroxydeceneoic acid, 3-hydroxytetradecenoic acid, 3-hydroxydodecanoic acid, 3-hydroxydodecenoic acid, 3-hydroxyoctanoic acid, 3-hydroxydodec-dienoic acid, and 3-hydroxydecaneoic acid.

7. The anti-microbial system of claim 1, wherein the amount of at least one of the mono-rhamno, mono-lipid of structure I and the di-rhamno, mono-lipid of structure II is 25 wt % or more, based on the total weight of rhamnolipids.

8. The anti-microbial system of claim 6, wherein the total amount of the mono-rhamno, mono-lipid of structure I and the di-rhamno, mono-lipid of structure II is 50 wt % or more, based on the total weight of rhamnolipids.

9. The anti-microbial system of claim 7, wherein the total amount of the mono-rhamno, mono-lipid of structure I and the di-rhamno, mono-lipid of structure II is 80 wt % or more, based on the total weight of rhamnolipids.

10. The anti-microbial system of claim 1, wherein the cation is selected from Na+, K+, Li+, Cs+, +NH3R2; +NH2R2R3; +NHR2R3R4, and +NR2R3R4R5, wherein R2, R3, R4, and R5 are each independently selected from an alkyl, branched alkyl, and cyclic alkyl.

11. The anti-microbial system of claim 1, further comprising less than 25 wt % of a rhamno di-lipid, based on the total weight of rhamnolipids in the anti-microbial system.

12. The anti-microbial system of claim 1, wherein the mono-rhamno, mono-lipid is selected from 3-(((2R,3R,4R,5R,6S)-3,4,5-trihydroxy-6-methyltetrahydro-2H-pyran-2-yl)oxy)hexadecanoic acid, 3-(((2R,3R,4R,5R,6S)-3,4,5-trihydroxy-6-methyltetrahydro-2H-pyran-2-yl)oxy)octenoic acid, 3-(((2R,3R,4R,5R,6S)-3,4,5-trihydroxy-6-methyltetrahydro-2H-pyran-2-yl)oxy)decenoic acid, 3-(((2R,3R,4R,5R,6S)-3,4,5-trihydroxy-6-methyltetrahydro-2H-pyran-2-yl)oxy)octanoic acid, 3-(((2R,3R,4R,5R,6S)-3,4,5-trihydroxy-6-methyltetrahydro-2H-pyran-2-yl)oxy)tetradecanoic acid, 3-(((2R,3R,4R,5R,6S)-3,4,5-trihydroxy-6-methyltetrahydro-2H-pyran-2-yl)oxy)decanoic acid, 3-(((2R,3R,4R,5R,6S)-3,4,5-trihydroxy-6-methyltetrahydro-2H-pyran-2-yl)oxy)dodecanoic acid, 3-(((2R,3R,4R,5R,6S)-3,4,5-trihydroxy-6-methyltetrahydro-2H-pyran-2-yl)oxy)dodecen-dienoic acid, and stereoisomers thereof.

13. The anti-microbial system of claim 1, wherein the di-rhamno, mono-lipid is selected from 3-(((2R,3R,4R,5R,6S)-4,5-dihydroxy-6-methyl-3-(((2R,3S,4S,5S,6S)-3,4,5-trihydroxy-6-methyltetrahydro-2H-pyran-2-yl)oxy)tetrahydro-2H-pyran-2-yl)oxy)hexadecanoic acid, 3-(((2R,3R,4R,5R,6S)-4,5-dihydroxy-6-methyl-3-(((2R,3S,4S,5S,6S)-3,4,5-trihydroxy-6-methyltetrahydro-2H-pyran-2-yl)oxy)tetrahydro-2H-pyran-2-yl)oxy)tetradecanoic acid, 3-(((2R,3R,4R,5R,6S)-4,5-dihydroxy-6-methyl-3-(((2R,3S,4S,5S,6S)-3,4,5-trihydroxy-6-methyltetrahydro-2H-pyran-2-yl)oxy)tetrahydro-2H-pyran-2-yl)oxy)decenoic acid, 3-(((2R,3R,4R,5R,6S)-4,5-dihydroxy-6-methyl-3-(((2R,3S,4S,5S,6S)-3,4,5-trihydroxy-6-methyltetrahydro-2H-pyran-2-yl)oxy)tetrahydro-2H-pyran-2-yl)oxy)tetradecenoic acid, 3-(((2R,3R,4R,5R,6S)-4,5-dihydroxy-6-methyl-3-(((2R,3S,4S,5S,6S)-3,4,5-trihydroxy-6-methyltetrahydro-2H-pyran-2-yl)oxy)tetrahydro-2H-pyran-2-yl)oxy)decanoic acid, 3-(((2R,3R,4R,5R,6S)-4,5-dihydroxy-6-methyl-3-(((2R,3S,4S,5S,6S)-3,4,5-trihydroxy-6-methyltetrahydro-2H-pyran-2-yl)oxy)tetrahydro-2H-pyran-2-yl)oxy)octanoic acid, and 3-(((2R,3R,4R,5R,6S)-4,5-dihydroxy-6-methyl-3-(((2R,3S,4S,5S,6S)-3,4,5-trihydroxy-6-methyltetrahydro-2H-pyran-2-yl)oxy)tetrahydro-2H-pyran-2-yl)oxy)dodecanoic acid, and stereoisomers thereof.

14. An anti-microbial composition, comprising:
a) an anti-microbial system comprising;
(i) a mono-rhamno, mono-lipid of structure I: 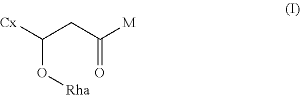
and
(ii) a di-rhamno, mono-lipid of structure II: 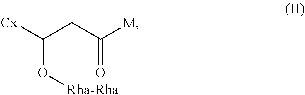
wherein:
Rha is rhamnose,
Cx is a C4-C22 alkyl, aryl, heteroalkyl, heteroaryl, unsaturated alkenyl, or unsaturated heteroalkenyl, and
M is a OH, alkyl, heteroalkyl, aryl, heteroaryl, hetero arylalkyl, arylalkyl, tauryl, O—X+, wherein X+ is a cation, or O—R1, wherein R1 is selected from an alkyl, branched alkyl, and cyclic alkyl, and stereoisomers thereof; and
b) a carrier.

15. The anti-microbial composition of claim 14, wherein the carrier is an aqueous carrier.

16. The anti-microbial composition of claim 15, further comprising an additional ingredient.

17. A preservative system, comprising:
a) a preservative composition comprising;
(i) a mono-rhamno, mono-lipid of structure I: 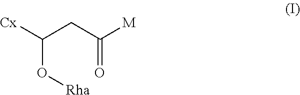
and
(ii) a di-rhamno, mono-lipid of structure II: 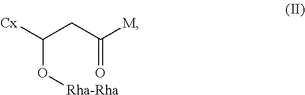
wherein:
Rha is rhamnose,
Cx is a C4-C22 alkyl, aryl, heteroalkyl, heteroaryl, unsaturated alkenyl, or unsaturated heteroalkenyl, and
M is a OH, alkyl, heteroalkyl, aryl, heteroaryl, hetero arylalkyl, arylalkyl, tauryl, O—X+, wherein X+ is a cation, or O—R1, wherein R1 is selected from an alkyl, branched alkyl, and cyclic alkyl, and stereoisomers thereof; and
b) a carrier.

18. The preservative system of claim 17, wherein the preservative system further comprises an additional preservative system selected from benzoates, salicylates, sorbates, phenoxyethanol, parabens, caprylyl glycol, substituted ureas, hydantoin derivatives, and combinations thereof.

19. The preservative system of claim 17, wherein the preservative system exhibits a minimum inhibitory concentration against S. aureus of less than 100 ppm, according to the Minimal Inhibitory Concentration method.

20. The anti-microbial system of claim 1, wherein the anti-microbial system exhibits at least one of a minimum kill concentration against E. coli of less than about 20,000 ppm and a minimum kill concentration against S. aureus of less than about 35,000 ppm, according to the MKCA.
